(19) United States
(12) Patent Application Publication
(10) Pub. No.: US 2014/0318220 A1
(43) Pub. Date: Oct. 30, 2014

(54) PRESSURE MEASURING DEVICE, PRESSURE MEASURING METHOD AND LEAKAGE INSPECTING DEVICE

(71) Applicant: HONDA MOTOR CO., LTD., Tokyo (JP)

(72) Inventor: Jun SAWADA, Wako-shi (JP)

(73) Assignee: HONDA MOTOR CO., LTD., Tokyo (JP)

(21) Appl. No.: 14/258,196

(22) Filed: Apr. 22, 2014

(30) Foreign Application Priority Data
Apr. 24, 2013 (JP) 2013-091632

(51) Int. Cl. G01L 7/00; G01M 3/02

(52) U.S. Cl. CPC G01L 7/00; G01M 3/02
USPC 73/40; 73/700

(57) ABSTRACT

A pressure measuring device includes: a tube fixable to a sample body along its surface; a pressure sensor and a closing plug both fixed inside the tube with a predetermined gap therebetween; a pipe for supplying reference pressure; a space defined between the sensor and the plug; and a pressure detecting hole penetrating the tube and communicating with the space. Since a volume of the space between the sensor and the plug is small, unsteady pressure fluctuations to be measured are prevented from being made unclear, thereby improving measurement accuracy. Additionally, the volume is set such that a Helmholtz resonance frequency of the space lies outside fluctuation frequencies of the unsteady pressure, thereby preventing superposition of pressure fluctuations by Helmholtz resonance on the unsteady pressure fluctuations to be measured, thus, further improving the measurement accuracy.

### CROSS REFERENCES TO RELATED APPLICATIONS

The present application claims priority under 35 U.S.C. §119 to Japanese Patent Application No. 2013-91632 filed Apr. 24, 2013 the entire contents of which are hereby incorporated by reference.

### BACKGROUND OF THE INVENTION

1. Field of the Invention

The present invention relates to a pressure measuring device, comprising: a tube capable of being fixed to a sample body along a surface thereof; a pressure sensor fixed inside the tube; a pipe for supplying reference pressure to the pressure sensor; a closing plug fixed inside the tube to have a predetermined gap from the pressure sensor; a space defined between the pressure sensor and the closing plug inside the tube; and a pressure detecting hole penetrating the tube to communicate with the space, in which unsteady pressure on the surface of the sample body is measured by transmitting the unsteady pressure to the pressure sensor through the pressure detecting hole and the space. In addition, the present invention also relates to a pressure measuring method using the pressure measuring device and a leakage inspecting device for inspecting leakage of the tube of the pressure measuring device.

2. Description of the Related Art

Japanese Patent Application Laid-open No. 62-35235 has made known a technique of measuring distribution of pressure on a surface of a vehicle body of an automobile by: forming through-holes inside a plate-shaped member attached to the surface of the vehicle body, each through-hole having one end opened at an upper surface of the plate-shape member and the other end opened at a peripheral edge portion of the plate-shaped member; and connecting the through-hole opened at the peripheral edge portion of the plate-shaped member to a pressure measuring unit through a pressure output member.

Moreover, Japanese Patent Application Laid-open No. 2009-25314 has made known a technique of measuring temperature of and pressure on a surface of a body of an airplane by: housing sensors, circuits, a battery, and the like inside a flexible substrate bonded to the surface of the body; and communicating the sensors with ambient air through ports provided in the flexible substrate.

### SUMMARY OF THE INVENTION

Meanwhile, according to the technique described in Japanese Patent Application Laid-open No. 62-35235, pressure sensors are provided outside the plate-shaped member, and the openings at the upper surface of the plate-shaped members and the pressure sensors are connected to each other through the long through-holes formed inside the plate-shaped member. Thus, the technique is capable of measuring the distribution of steady pressure on the surface of the vehicle body. However, in a case of measuring unsteady and subtle pressure fluctuations on the surface of the vehicle body, the pressure fluctuations are made unclear through the long through-holes, thereby causing a problem of being unable to obtain sufficient measurement accuracy.

Moreover, according to the technique described in Japanese Patent Application Laid-open No. 2009-25314, the sensors are provided near the ports opened in the flexible board. Thus, the problem that unsteady pressure fluctuations on the surface of the body are made unclear does not exist. However, air in a space between each port and its corresponding sensor vibrates due to Helmholtz resonance, and the resultant pressure fluctuations are superposed on the pressure fluctuations on the surface of the body to be measured, thereby causing a problem of deteriorating the measurement accuracy. In addition, in the case of the above technique, reference pressure, which serves as a reference, cannot be inputted to the sensor, and only absolute pressure can be measured, thereby causing a problem of low measurement accuracy.

The present invention has been made in view of the above circumstances, and an object thereof is to provide a pressure measuring device capable of accurately measuring unsteady and subtle pressure fluctuations on a surface of a sample body.

In order to achieve the object, according to a first feature of the present invention, there is provided a pressure measuring device, comprising: a tube capable of being fixed to a sample body along a surface thereof; a pressure sensor fixed inside the tube; a pipe for supplying reference pressure to the pressure sensor; a closing plug fixed inside the tube to have a predetermined gap from the pressure sensor; a space defined between the pressure sensor and the closing plug inside the tube; and a pressure detecting hole penetrating the tube to communicate with the space, in which unsteady pressure on the surface of the sample body is measured by transmitting the unsteady pressure to the pressure sensor through the pressure detecting hole and the space, wherein a volume of the space is set such that a Helmholtz resonance frequency of the space lies outside frequencies of fluctuations of the unsteady pressure.

According to the first feature of the present invention, the pressure measuring device includes: the tube capable of being fixed to the sample body along the surface thereof; the pressure sensor fixed inside the tube; the pipe for supplying the reference pressure to the pressure sensor; the closing plug fixed inside the tube to have the predetermined gap from the pressure sensor; the space defined between the pressure sensor and the closing plug inside the tube; and the pressure detecting hole penetrating the tube to communicate with the space. Thus, the unsteady pressure on the surface of the sample body can be measured by transmitting to the pressure sensor through the pressure detecting hole and the space. Moreover, since the volume of the space between the pressure sensor and the closing plug both fixed inside the tube is small, the unsteady pressure fluctuations to be measured are prevented from being made unclear. Thus, the measurement accuracy is improved. In addition to this, the volume of the space is set such that the Helmholtz resonance frequency of the space lies outside the frequencies of the fluctuations of the unsteady pressure, thereby preventing the situation where pressure fluctuations caused by Helmholtz resonance are superposed on the unsteady pressure fluctuations to be measured. Thus, the measurement accuracy is further improved.

According to a second feature of the present invention, in addition to the first feature, the pressure sensor is in contact with the closing plug, and the space is formed of a recess formed in a surface of the closing plug facing the pressure sensor.

According to the second feature of the present invention, the pressure sensor is in contact with the closing plug, and the space is formed of the recess formed in the surface of the closing plug facing the pressure sensor. Thus, the relative positional relation between the closing plug and the pressure sensor is maintained constantly. Accordingly, the set Helmholtz resonance frequency can be prevented from being deviated.

According to a third feature of the present invention, in addition to the first or second feature, a signal line for transmitting a pressure signal outputted from the pressure sensor is formed of a shielded wire for blocking noise from outside.

According to the third feature of the present invention, the signal line for transmitting the pressure signal outputted from the pressure sensor is formed of the shielded wire for blocking the noise from the outside. Thus, the signal line which extends long along the tube hardly picks up the noise. Accordingly, the measurement accuracy can be enhanced.

According to a fourth feature of the present invention, there is provided a pressure measuring method using the pressure measuring device according to the first or second feature, wherein noise in a pressure signal outputted from a first pressure sensor as said pressure sensor disposed inside air flow is removed with a pressure signal outputted from a second pressure sensor as said pressure sensor disposed outside the air flow.

According to the fourth feature of the present invention, the pressure signal outputted from the first pressure sensor disposed inside the air flow is calibrated with the pressure signal outputted from the second pressure sensor disposed outside the air flow. Thus, spike noise in the pressure signal of the first pressure sensor are cancelled out by spike noise in the pressure signal of the second pressure sensor. Accordingly, the unsteady pressure fluctuations to be measured can be measured accurately.

According to a fifth feature of the present invention, there is provided a leakage inspecting device for inspecting leakage of the tube of the pressure measuring device according to the first or second feature, comprising: an annular adhesive part capable of detachably adhering to a periphery of the pressure detecting hole in the tube; a pressure piping connected at one end to the adhesive part; and a pressurizing device connected to the other end of the pressure piping.

According to the fifth feature of the present invention, the leakage inspecting device includes: the annular adhesive part capable of detachably adhering to the periphery of the pressure detecting hole in the tube; the pressure piping connected at the one end to the adhesive part; and the pressurizing device connected to the other end of the pressure piping. Thus, presence or absence of the leakage can be determined by pressurizing a path from the pressurizing device to the pressure sensor via the pressure piping, the pressure detecting hole, and the space so as to monitor how the pressure changes. At this time, the adhesive part adheres to the periphery of the pressure detecting hole in the tube. Thus, while leakage inspection is performed, an operator does not need to hold the pressure piping with his or her hand. Accordingly, workability is improved significantly.

Note that a strip tube 11 of an embodiment corresponds to the tube of the present invention, a vehicle body 18 of the embodiment corresponds to the sample body of the present invention, and a standard pressure generator 22 of the embodiment corresponds to the pressurizing device of the present invention. The above and other objects, characteristics and advantages of the present invention will be clear from detailed descriptions of the preferred embodiment which will be provided below while referring to the attached drawings.

### BRIEF DESCRIPTION OF THE DRAWINGS

FIG. 1 is an exploded perspective view of a pressure measuring device.

FIG. 2A is a sectional view taken along line 2A-2A in FIG. 1 and FIGS. 2B to 2D are sectional views taken along line 2B-2B, line 2C-2C and line 2D-2D, respectively, in FIG. 2A.

FIG. 3 is a schematic view showing a sample body placed in a wind tunnel.

FIG. 4 is an explanatory diagram of a Helmholtz resonance frequency.

FIG. 5 is a power spectrum of pressure fluctuations on a surface of the sample body (with no noise countermeasure).

FIG. 6 is a power spectrum of pressure fluctuations on the surface of the sample body (with noise countermeasure by hardware).

FIG. 7 is a power spectrum of pressure fluctuations on the surface of the sample body (further with noise countermeasure by software).

FIGS. 8A and 8B are graphs for comparing output of a normal pressure sensor and output of a dummy pressure sensor.

FIGS. 9A and 9B are graphs for comparing a result of a FFT process on the output of the normal pressure sensor and a result of the FFT process on the output of the dummy pressure sensor.

FIG. 10 is a perspective view of a connecting member.

FIG. 11 is a sectional view taken along line 11-11 in FIG. 10.

### DESCRIPTION OF THE PREFERRED EMBODIMENT

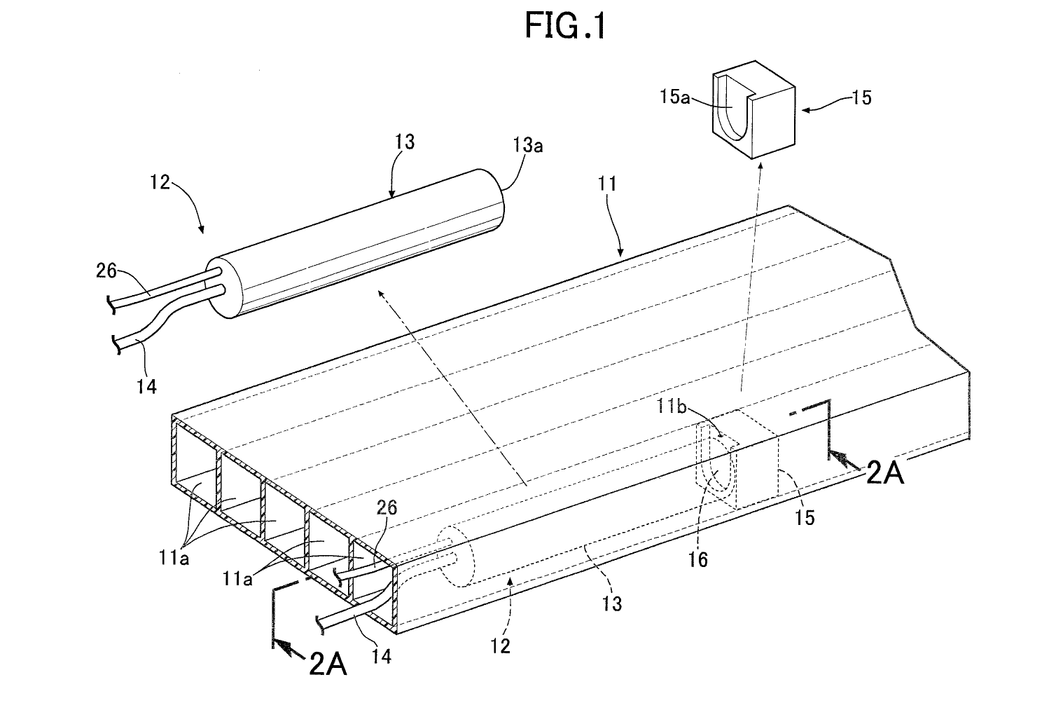

Hereinafter, an embodiment of the present invention will be described with reference to FIGS. 1 to 11.

A pressure measuring device of this embodiment is used to measure unsteady pressure on a surface of a vehicle body of an automobile, for example, unsteady pressure on a surface of a front window glass which disturbed air flow behind a side mirror of the automobile hits, or unsteady pressure on a portion of a rear surface of a rear bumper of the automobile from which air flow separates.

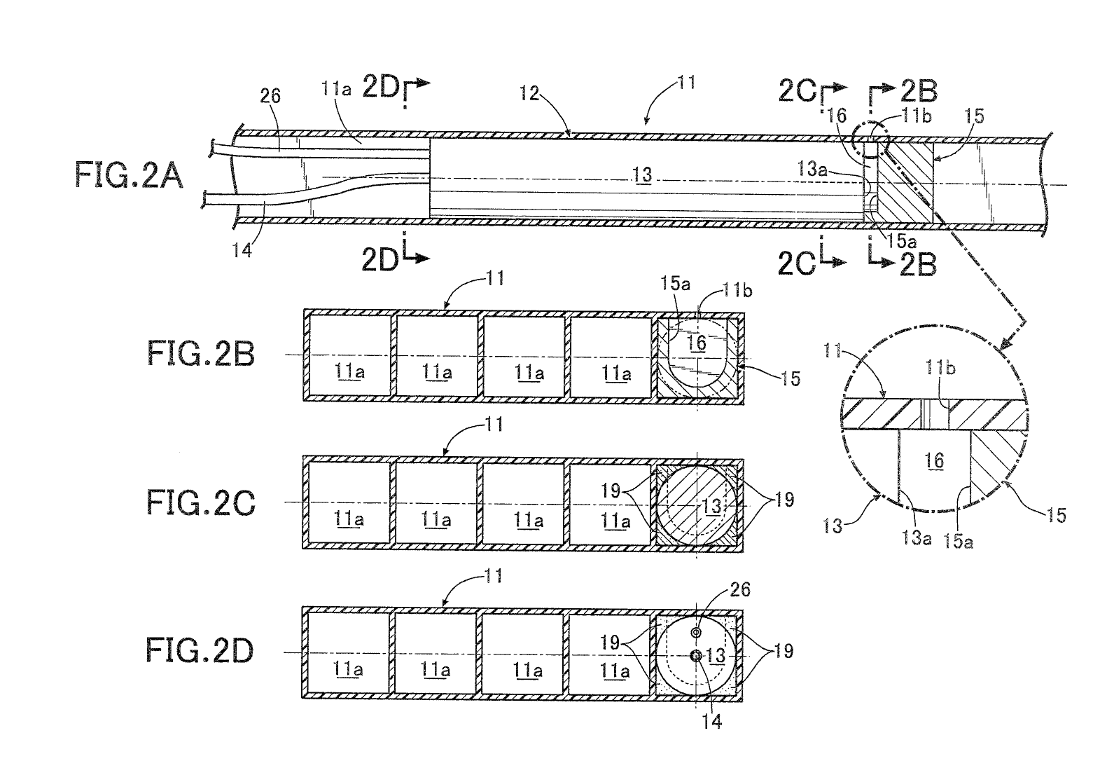

As shown in FIGS. 1 and 2A to 2D, the pressure measuring device includes a strip tube 11 made of a synthetic resin to be attached to the surface of the vehicle body. The strip tube 11 is a strip-shaped member having flexibility, and its thickness is suppressed to 3 mm or below, for example, so as to reduce an influence which the strip tube 11 causes to air flow. Inside the strip tube 11, multiple (five in the embodiment) hollow parts 11a each having a square section and extending in parallel with each other are formed along a longitudinal direction of the strip tube 11. The strip tube 11 having such a shape can be manufactured by using a method such as cutting, extrusion molding, stereolithography and the like.

Each hollow part 11a of the strip tube 11 houses a pressure sensor 12 formed of a semiconductor sensor. The pressure sensor 12 includes a cylindrical sensor body 13 and a signal line 14 led out from one end surface of the sensor body 13. An inner diameter of the sensor body 13 is substantially equal to a length of one side of the hollow part 11a. When the sensor body 13 is fixed at a predetermined position in the hollow part 11a of the strip tube 11 with adhesive 19 (see FIGS. 2C and 2D), the adhesive 19 seals gaps between an outer surface of the sensor body 13 and an inner surface of the hollow part 11a.

A pipe 26 for supplying reference pressure serving as a reference is connected to the sensor body 13 through the hollow part 11a of the strip tube 11, and the sensor body 13 detects pressure relative to the reference pressure. Moreover, the signal line 14 is formed of a shielded wire covered with a cover that blocks electromagnetic waves so that the signal line 14 housed in the hollow part 11a of the strip tube 11 can be prevented from picking up noise.

A cubic closing plug 15 is inserted in the hollow part 11a of the strip tube 11 and is fixed with adhesive in such a way as to be in contact with a pressure detecting surface 13a which forms the other end surface of the sensor body 13. The closing plug 15 is made of metal, and an end surface thereof facing the pressure detecting surface 13a of the sensor body 13 is cut out into a U-shaped recess 15a. A space 16 of a predetermined volume is formed between this recess 15a and the pressure detecting surface 13a of the sensor body 13. A cylindrical pressure detecting hole 11b penetrating the strip tube 11 communicates with the space 16.

The pressure sensor 12 and the closing plug 15 are disposed in each of the five hollow parts 11a of the strip tube 11. Here, positions to dispose the pressure sensor 12 and the closing plug 15 may be shifted in the longitudinal direction of the strip tube 11 or aligned in a direction perpendicular to the longitudinal direction of the strip tube 11. Moreover, the pressure sensor 12 and the closing plug 15 are not necessarily disposed in all hollow parts 11a of the strip tube 11; the pressure sensor 12 and the closing plug 15 may be disposed only in one or a plurality of predetermined hollow parts 11a as needed.

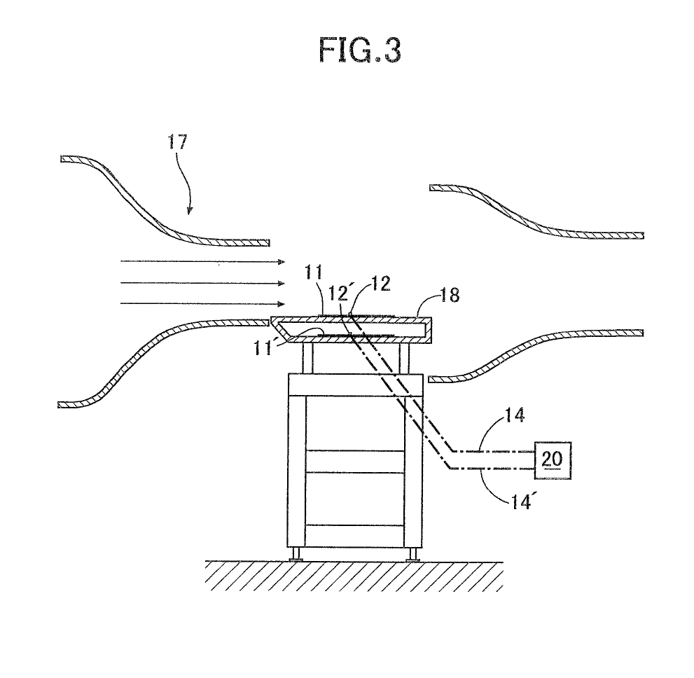

As shown in FIG. 3, two strip tubes 11, 11′ are attached to portions of a surface of a vehicle body 18 of an automobile which is a sample body placed inside a wind tunnel 17. One is a normal strip tube 11 attached to a portion where pressure measurement is to be performed, while the other is a dummy strip tube 11′ attached to a portion exposed to no wind. A normal pressure sensor 12 and a dummy pressure sensor 12′ are provided inside the normal strip tube 11 and the dummy strip tube 11′, respectively. The normal strip tube 11 and the dummy strip tube 11′ are completely the same, and the normal pressure sensor 12 and the dummy pressure sensor 12′ are completely the same as well.

Signal lines 14, 14′ extending from the two pressure sensors 12, 12′, respectively, are led out from end portions of the strip tubes 11, 11′, respectively, through the respective hollow parts 11a so as to be connected to an external pressure measuring unit 20. The pressure measuring unit 20 amplifies and A/D converts pressure signals outputted by the two pressure sensors 12, 12′, and then performs a process to remove spike noise, thereby calculating pressures at the pressure detecting holes 11b.

Meanwhile, the pressure measuring device of this embodiment is configured to measure subtle pressure fluctuations in a frequency domain of 1 Hz to 10 KHz, for example, of unsteady air flow flowing on the surface of the vehicle body 18. Here, assume that the pressure sensor 12 is provided outside the strip tube 11 and that the pressure detecting hole 11b in the strip tube 11 and the pressure sensor 12 are connected to each other through the elongated hollow part 11a of the strip tube 11. In this case, unsteady and subtle pressure fluctuations on the surface of the vehicle body 18 are made unclear through the elongated hollow part 11a, thus causing a problem of being unable to obtain sufficient measurement accuracy. However, in this embodiment, the pressure sensor 12 is provided in proximity to the pressure detecting hole 11b, thereby eliminating a problem of deterioration of the measurement accuracy due to pressure fluctuations made unclear through the elongated hollow part 11a.

As described above, in this embodiment, the pressure fluctuations on the surface of the vehicle body 18 can be measured without being made unclear by reducing a size of the space 16 which the pressure detecting surface 13a of the sensor body 13 of the pressure sensor 12 faces. On the other hand, if air in the space 16 resonates due to unsteady air flow flowing outside the pressure detecting hole 11b (Helmholtz resonance), and a frequency of that resonance is close to the frequencies of the pressure fluctuations to be measured (e.g. 1 Hz to 10 KHz), the measurement accuracy of the pressure sensor 12 might possibly be deteriorated. Hereinbelow, a countermeasure against the Helmholtz resonance will be described.

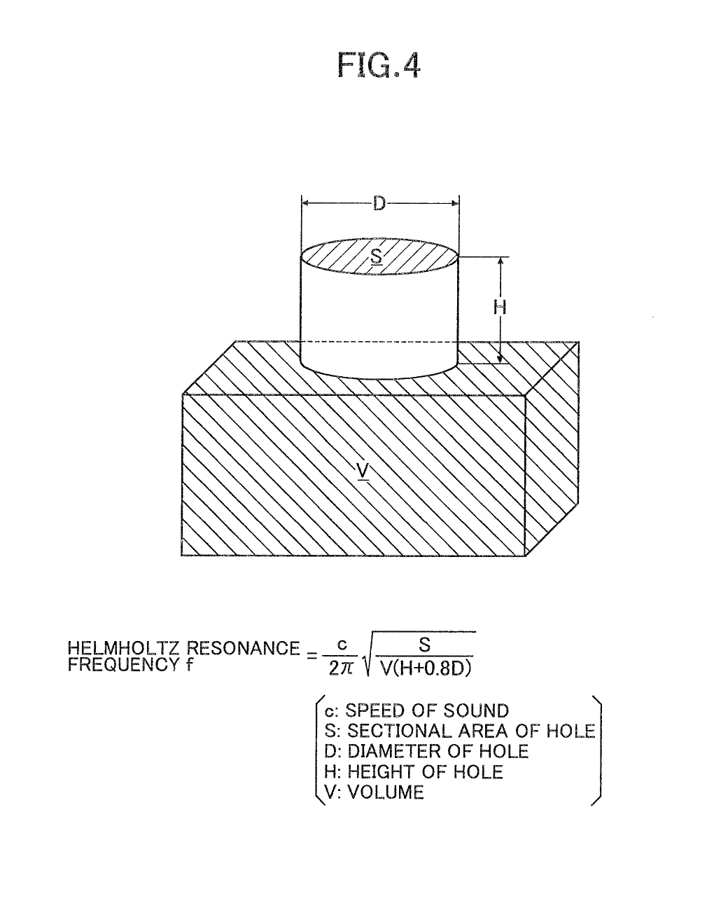

As shown in FIG. 4, the space 16 and the pressure detecting hole 11b in the strip tube 11 can be modeled as a structure including a box as the space 16 and a nozzle as the pressure detecting hole 11b attached to the box. When supposing a virtual vibration system having air inside the nozzle as a mass and air inside the box as a spring, its resonance frequency is called a Helmholtz resonance frequency. When a volume of the space 16 is V, a diameter of the pressure detecting hole 11b is D, a height of the pressure detecting hole 11b is H, a sectional area of the pressure detecting hole 11b is S, and a speed of sound is c, a Helmholtz resonance frequency f of the space 16 is expressed as below.

$$f = \frac{c}{2 π} \sqrt{\frac{S}{V ( H + 0.8 D )}} \qquad [ Formula 1 ]$$

Thus, a shape of the recess 15a of the closing plug 15 is changed so as to change the volume V of the space 16 formed therein such that the Helmholtz resonance frequency f of the space 16 is shifted to a domain higher than 10 KHz. Accordingly, deterioration of the pressure measurement accuracy can be prevented. Here, since adjustment of the Helmholtz resonance frequency f of the space 16 can be done simply by changing the shape of the recess 15a of the closing plug 15, the adjustment is extremely easy. In addition, since the closing plug 15 is fixed at such a position as to contact the pressure detecting surface 13a of the sensor body 13, the volume V of the space 16 can always be maintained at a constant volume.

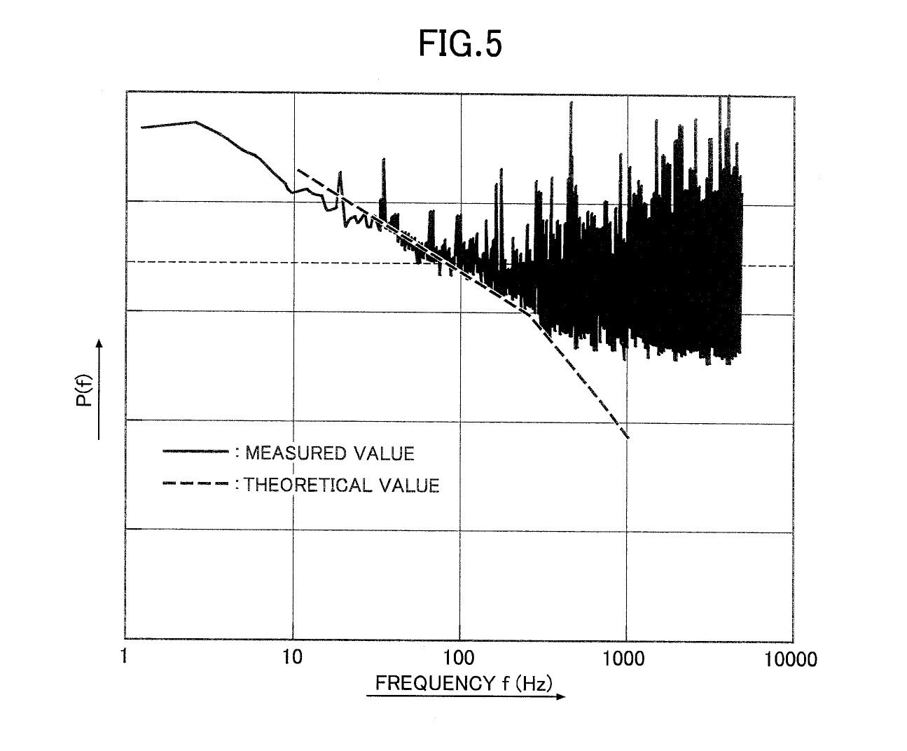

FIG. 5 is a power spectrum of pressure fluctuations on the surface of the vehicle body 18 before a countermeasure by hardware such as a shield and the like is taken for the signal line 14. A broken line corresponds to theoretical values, and a solid line corresponds to measured values. The measured values indicated by the solid line contain large noise, and a predetermined pressure resolution is not achieved (see the broken line). Note that a vertical axis in each of FIGS. 5 to 7 is a logarithmic scale, and each point in the scale is equivalent to pressure 10 times.

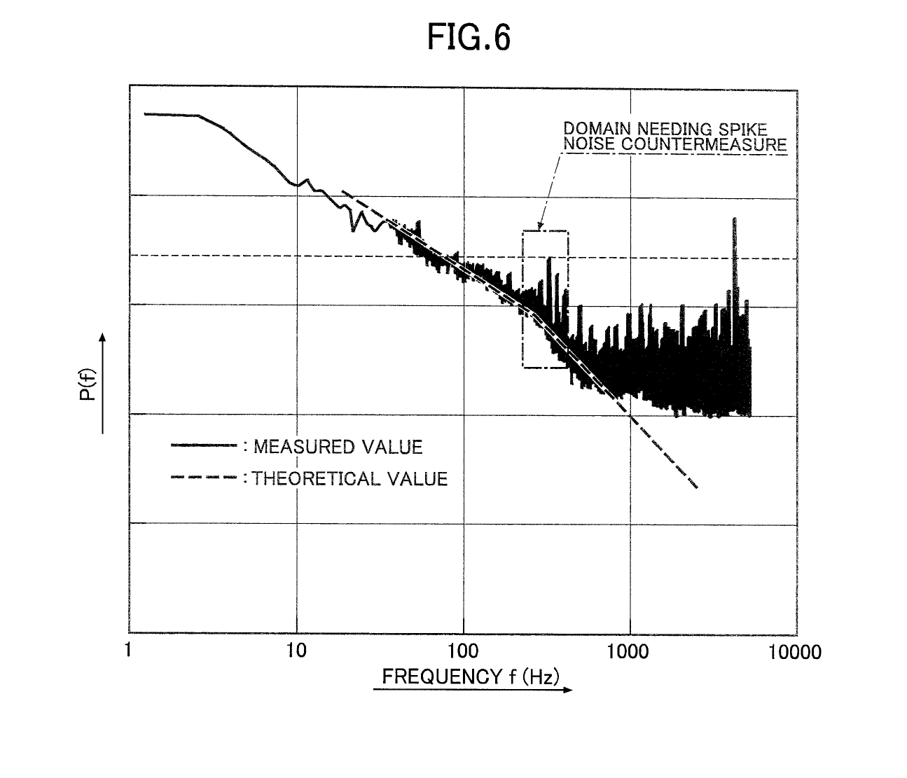

FIG. 6 is a power spectrum of pressure fluctuations on the surface of the vehicle body 18 after the above-mentioned countermeasure by hardware is taken. Since the noise is reduced, the resolution is improved (see the broken line). However, the predetermined pressure resolution is still not achieved. Thus, a spike noise countermeasure by software is necessary.

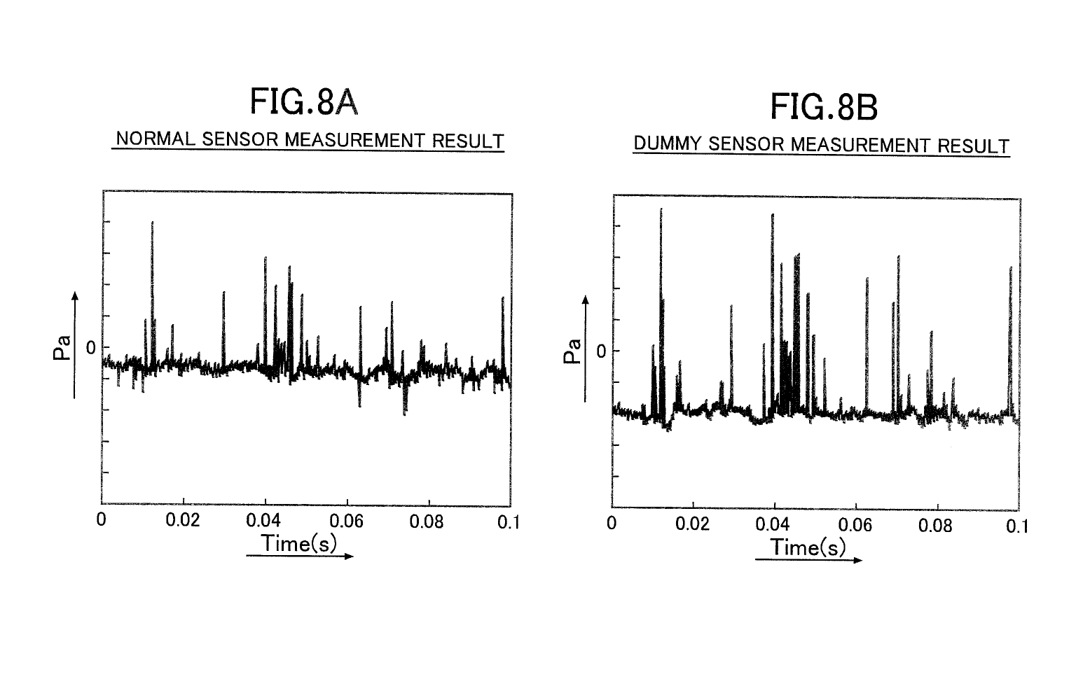

Specifically, as clearly seen from a comparison of an output signal of the normal pressure sensor 12 shown in FIG. 8A and an output signal of the dummy pressure sensor 12′ shown in FIG. 8B, the output signals of the two pressure sensors 12, 12′ contain spike noise at the same time, but it is impossible to remove the noise component even if the output signals are directly subtracted from each other.

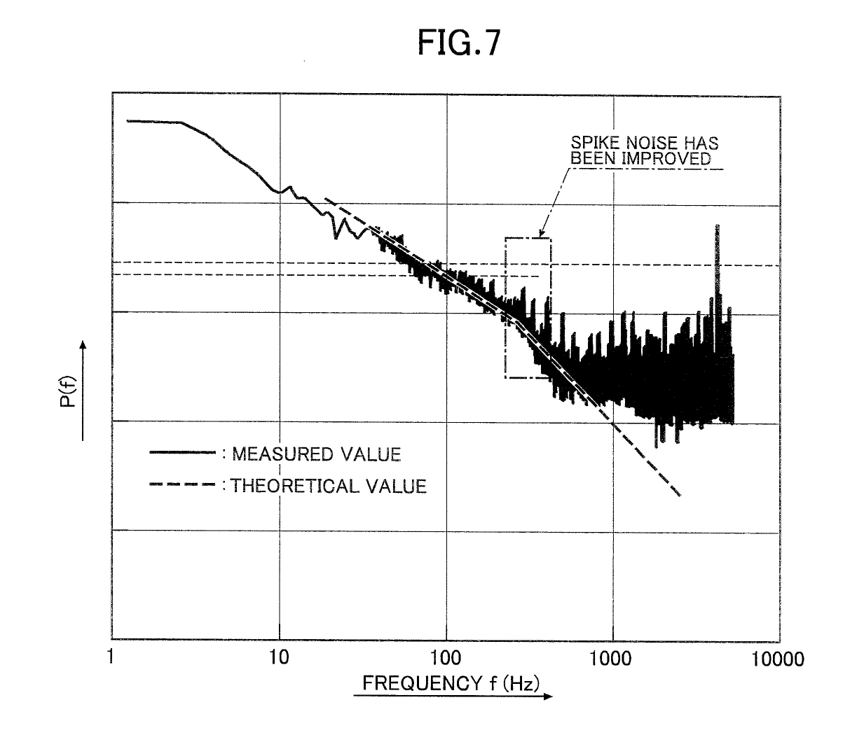

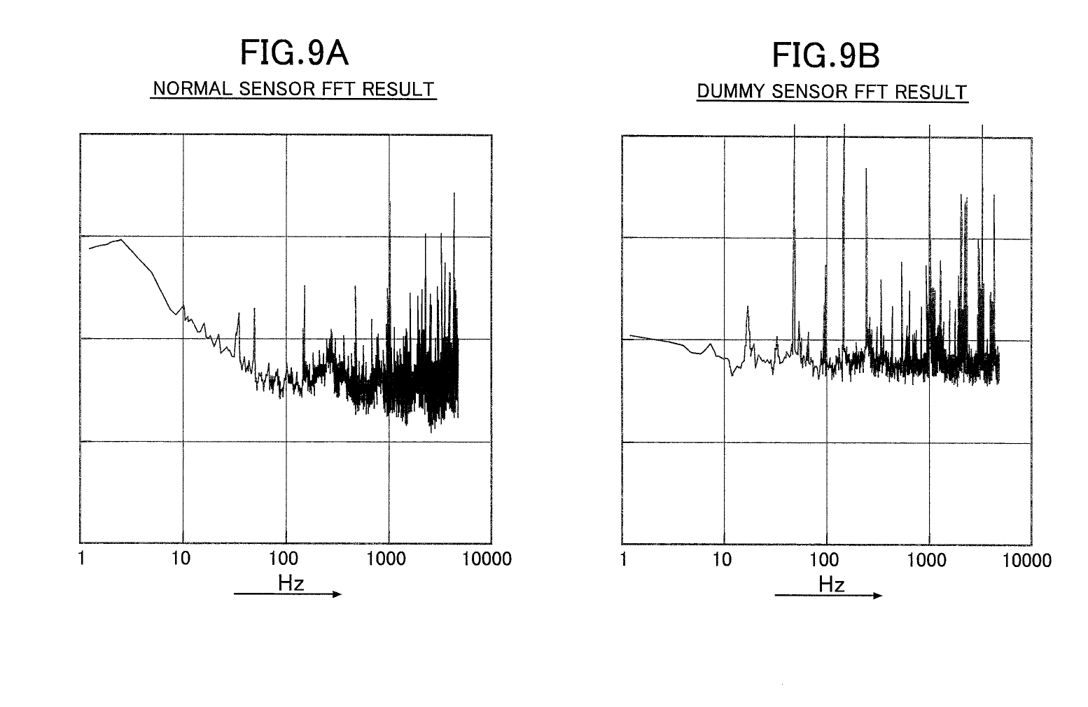

For this reason, as shown in FIGS. 9A and 9B, FFT (fast Fourier transform) is performed to the output signals of the two pressure sensors 12, 12′, and the results are subtracted from each other in the frequency domain. FIG. 7 shows that the noise component is greatly reduced and the predetermined pressure resolution is obtained (see the broken line).

Next, a method of checking leakage of the strip tube 11 and a method of checking wiring of the signal lines 14 will be described.

In the hollow part 11a of the strip tube 11, the space 16 sandwiched between the pressure sensor 12 and the closing plug 15 is defined, and the space 16 communicates with ambient air through the pressure detecting hole 11b. The pressure measurement accuracy of the pressure sensor 12 is deteriorated if, for example, there is a gap between the hollow part 11a of the strip tube 11 and the pressure sensor 12 or between the hollow part 11a of the strip tube 11 and the closing plug 15, or there is a crack in the strip tube 11 in a portion facing the space 16. Thus, it is necessary to check airtightness of the space 16.

In addition, to measure distribution of pressure at each part on the vehicle body 18, the signal lines 14 of several tens or several hundreds of pressure sensors 12 need to be properly connected to the pressure measuring unit 20. Thus, it is necessary to check whether or not the signal lines 14 are properly wired.

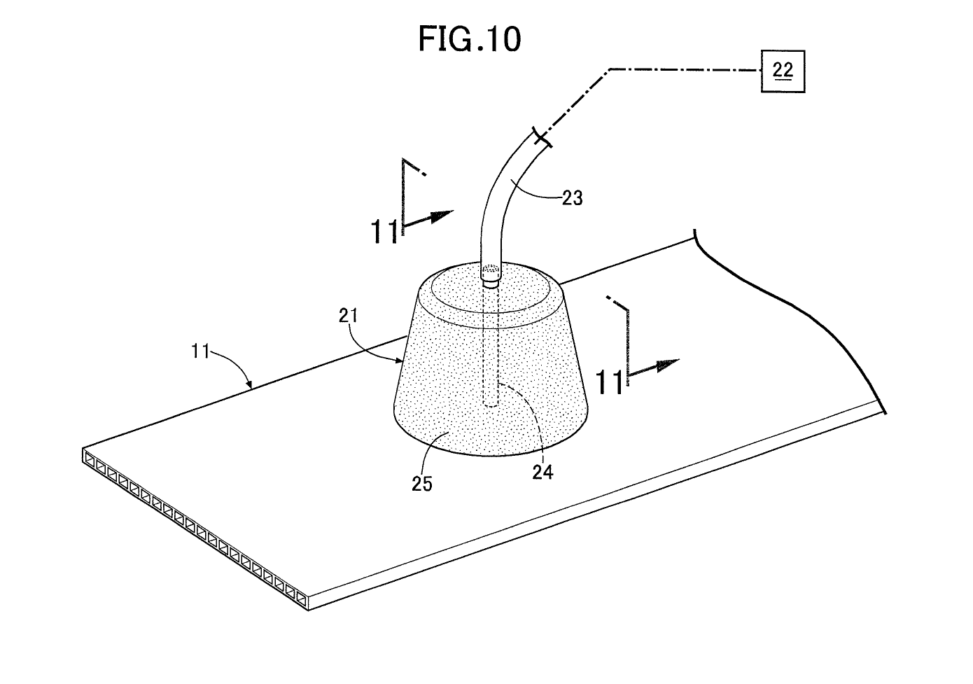

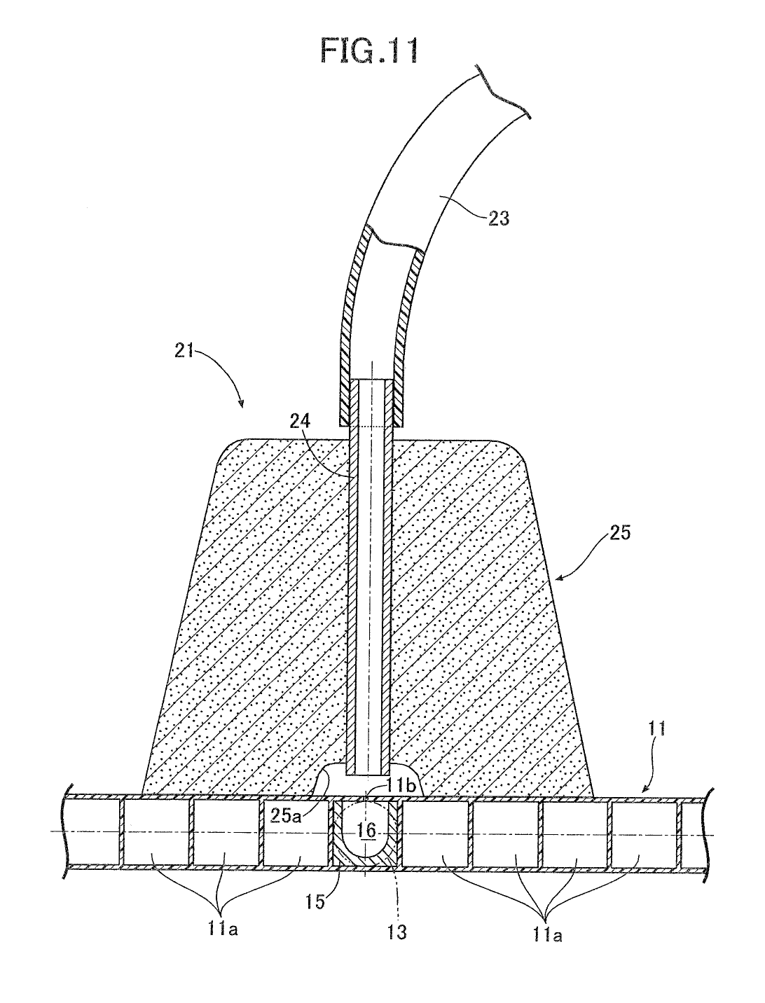

FIGS. 10 and 11 show a connecting member 21 for performing the leakage check and the wiring check. The connecting member 21 includes: a flexible pressure piping 23 connected to a standard pressure generator 22 which supplies predetermined pressure; a metal pipe 24 connected to a tip end of the pressure piping 23; and an adhesive part 25 provided in such a way as to surround an outer periphery of the metal pipe 24 and made of a flexible, self-adhesive material such as butylene rubber. The adhesive part 25 is capable of adhering to the strip tube 11 and the body 18 to which the strip tube 11 is attached, and is also capable of being detached many times so as to be repeatedly usable. In an adhering surface of a tip end of the adhesive part 25 formed in an annular shape, a circular recess 25a is formed, to which a tip end of the metal pipe 24 is opened.

Accordingly, in a state where the adhesive part 25 is adhered such that its recess 25a covers the pressure detecting hole 11b of the strip tube 11 attached to the vehicle body 18, standard pressure is supplied from the standard pressure generator 22 to the pressure detecting hole 11b of the strip tube 11 through the pressure piping 23 and the metal pipe 24 so as to monitor output of the pressure sensor 12, thereby being able to reliably determine occurrence of leakage. Moreover, once the adhesive part 25 is adhered, the adhesive part 25 is not be detached even with an operator's hand off, unless it is forcibly pulled. Thus, the operator does not need to hold the connecting member 21 with his or her hand during the check. Accordingly, workability is improved significantly.

Note that when the connecting member 21 is manufactured, the adhesive part 25 formed in a tape shape may be wound around the outer periphery of the metal pipe 24 so as to be able to be shaped into a predetermined shape without requiring any special mold. Accordingly, manufacturing cost is reduced.

Moreover, although the connecting member 21 is used in the embodiment for checking leakage of the strip tube 11 housing the pressure sensor 12 therein and for checking wiring of the signal line 14, the connecting member 21 can be used for checking strip tubes 11 other than the one mentioned above. For example, the connecting member 21 can be used to perform the leakage check and the wiring check even in a case where: the strip tube 11 has the pressure detecting hole 11b at one end or an intermediate portion of the hollow part 11a; the other end of the strip tube 11 is connected to a pressure sensor disposed outside; and static pressure in the pressure detecting hole 11b is transmitted to the pressure sensor through the hollow part 11a. In this case, if the strip tube 11 is bent in a middle, thereby closing the hollow part 11a, pressure from the standard pressure generator 22 is not be transmitted to the pressure sensor. Accordingly, it is possible to also determine whether or not the strip tube 11 is bent.

Although an embodiment of the present invention has been described above, various design changes can be made to the present invention without departing from the gist thereof.

For example, the sample body of the present invention is not limited to the vehicle body 18 of the automobile in the embodiment but may be a body of an aircraft, a body of a building, models thereof, or the like.

Moreover, although the pressure sensor 12 and the closing plug 15 are disposed in contact with each other in the embodiment, they may be disposed with a predetermined gap therebetween.

What is claimed is:

1. A pressure measuring device, comprising:
a tube capable of being fixed to a sample body along a surface thereof;
a pressure sensor fixed inside the tube;
a pipe for supplying reference pressure to the pressure sensor;
a closing plug fixed inside the tube to have a predetermined gap from the pressure sensor;
a space defined between the pressure sensor and the closing plug inside the tube; and
a pressure detecting hole penetrating the tube to communicate with the space, in which
unsteady pressure on the surface of the sample body is measured by transmitting the unsteady pressure to the pressure sensor through the pressure detecting hole and the space, wherein
a volume of the space is set such that a Helmholtz resonance frequency of the space lies outside frequencies of fluctuations of the unsteady pressure.

2. The pressure measuring device according to claim 1, wherein
the pressure sensor is in contact with the closing plug, and
the space is formed of a recess formed in a surface of the closing plug facing the pressure sensor.

3. The pressure measuring device according to claim 1 or 2, wherein a signal line for transmitting a pressure signal outputted from the pressure sensor is formed of a shielded wire for blocking noise from outside.

4. A pressure measuring method using the pressure measuring device according to claim 1 or 2, wherein noise in a pressure signal outputted from a first pressure sensor as said pressure sensor disposed inside air flow is removed with a pressure signal outputted from a second pressure sensor as said pressure sensor disposed outside the air flow.

5. A leakage inspecting device for inspecting leakage of the tube of the pressure measuring device according claim 1 or 2, comprising:
an annular adhesive part capable of detachably adhering to a periphery of the pressure detecting hole in the tube;
a pressure piping connected at one end to the adhesive part; and
a pressurizing device connected to the other end of the pressure piping.
